(19) United States
(12) Patent Application Publication
(10) Pub. No.: US 2026/0192304 A1
(43) Pub. Date: Jul. 9, 2026

(54) Thermal Tube Rack for Use With a Thermally Controllable Agitation Device

(71) Applicant: Becton, Dickinson and Company, Franklin Lakes, NJ (US)

(72) Inventor: Jeannine K. Funderburk, Cupertino, CA (US)

(21) Appl. No.: 19/226,475

(22) Filed: Jun. 3, 2025

Related U.S. Application Data
(60) Provisional application No. 63/655,872, filed on Jun. 4, 2024.

(51) Int. Cl. B01L 9/06; B01L 7/04

(52) U.S. Cl. CPC B01L 9/06; B01L 7/04; B01L 2200/025; B01L 2200/12; B01L 2300/0858; B01L 2300/12

(57) ABSTRACT

A tube rack for use with a thermally controllable agitation device is provided. The tube rack comprises a frame including a top frame portion and a bottom frame portion in a stacked arrangement, each of the top frame portion and the bottom frame portion including a plurality of sidewalls defining an inner volume, and each of the top frame portion and the bottom frame portion including one or more members having an array of openings formed therein configured to receive and retain specimen tubes therein. The tube rack also comprises an insert retained within the frame at a bottom end thereof, the insert comprising a flat bottom surface and a top surface that includes a plurality of wells formed therein configured to receive a rounded bottom end of the specimen tubes. The frame is formed of a thermally insulating material and the insert is formed of a thermally conducting material.

### CROSS-REFERENCE TO RELATED APPLICATION

The present application claims priority to U.S. Provisional Ser. No. 63/655,872 entitled “Thermal Tube Rack for Use with a Thermally Controllable Agitation Device” filed Jun. 4, 2024, the entire disclosure of which is hereby incorporated by reference.

### BACKGROUND OF THE INVENTION

### Field of the Invention

The present disclosure relates generally to a tube rack and, more particularly, to a thermal tube rack for use with a temperature control and mixing instrument.

### Description of Related Art

Used predominately in molecular biology applications, plate shakers are ideal for cell lysis, mixing tissue samples or cytogenetic suspensions, vortexing cell suspensions, and/or emulsifying bipolar viscous fluids for a homogenous blend. Plate shakers feature digital controls that manipulate the shaking speed and run time for specific testing requirements. Additionally, some plate shakers also include temperature regulation features that optimize/control the temperature of samples that are being agitated, with such temperature regulation also being adjustable via digital controls.

Existing plate shakers typically include a top coupling or carrier plate that accommodates positioning of a specimen holder thereon, with the carrier plate providing for agitation of the specimen holder and, optionally, for thermal regulation of the specimen holder (i.e., the specimen contained therein. One or more fastening devices may also be provided adjacent the carrier plate to secure the specimen holder to the carrier plate. Specimen holders that may be used with the plate shaker include microplates, as well as various tube or vial racks, with the exact configuration of the carrier plate and fastening device(s) depending on the specimen holder to be used.

With regard to tube racks and other specimen holders that may be used with plate shakers for sample preparation, existing tube racks and specimen holders may lack the ability to provide for accurate and consistent control of the temperature of the sample contained therein.

As one example, existing tube racks are typically configured as mono-material racks (i.e., plastic racks) that lack the capability of thermally coupling with the carrier plate of the temperature-controlling plate shaker. That is, as the plastic material of the rack does not provide thermal conductivity, the plastic molded wells 124 of the rack surround and insulate the bottom of the tubes from the temperature controlled carrier plate, thus inhibiting accurate temperature control of the specimens. Additionally, existing tube racks have an open-air architecture without enclosed perimeter walls, such that it is extremely difficult to maintain the temperature of the tubes in the perimeter positions of the tube rack at the desired temperature.

As another example, existing adapter plates or microplates are currently available that may be secured to the carrier plate of the plate shaker. Such adapter plates or microplates are typically formed entirely of metal (or another thermally conductive material), so as to provide thermal conductivity between the carrier plate and the adapter plate/microplate. However, such adapter plates or microplates are heavy and lack the capability of providing thermal insulation to the specimen, in order to make temperature regulation of the specimen easier. Still further, the existing adapter plates or microplates are limited in regard to the sample format that they may accommodate. As one example, existing adapter plates or microplates cannot accommodate Falcon® 5 mL round bottom polystyrene test tubes from Corning Inc., which may be run on a cytometer system for sample analysis.

Accordingly, a need exists in the art for improved tube holders that may be used with a temperature control and mixing instruments such as heating and cooling plate shakers. It would be desirable for such tube holders to provide thermal conductivity between the plate shaker and the tube holder, while also providing insulation of the specimen, in order to provide improved temperature regulation thereof.

### SUMMARY OF THE INVENTION

Provided herein is a tube rack for use with a thermally controllable agitation device. The tube rack comprises a frame including a top frame portion and a bottom frame portion in a stacked arrangement, each of the top frame portion and the bottom frame portion including a plurality of sidewalls defining an inner volume, and each of the top frame portion and the bottom frame portion including one or more members having an array of openings formed therein configured to receive and retain specimen tubes therein. The tube rack also comprises an insert retained within the frame at a bottom end thereof, the insert comprising a flat bottom surface and a top surface that includes a plurality of wells formed therein configured to receive a rounded bottom end of the specimen tubes. The frame is formed of a thermally insulating material and the insert is formed of a thermally conducting material.

### BRIEF DESCRIPTION OF THE DRAWINGS

FIG. 1 is a perspective view of a system for sample agitation and heating-cooling, according to an aspect or embodiment of the present application;

FIG. 2 is a perspective view of a thermally controllable agitation device included in the system of FIG. 1, according to an aspect or embodiment of the present application;

FIG. 3 is a top perspective view of a tube rack included in the system of FIG. 1, according to an aspect or embodiment of the present application;

FIG. 4 is a bottom perspective view of the tube rack of FIG. 3;

FIG. 5 is a cross-sectional view of the tube rack of FIG. 3; and

FIG. 6 is a perspective view of a thermal insert included in the tube rack of FIG. 3.

### DESCRIPTION OF THE INVENTION

The following description is provided to enable those skilled in the art to make and use the described aspects contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present disclosure.

For the purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawings. However, it is to be understood that the invention may assume various alternative variations, except where expressly specified to the contrary. It is also to be understood that the specific devices illustrated in the attached drawings, and described in the following specification, are simply exemplary aspects of the invention. Hence, specific dimensions and other physical characteristics related to the aspects disclosed herein are not to be considered as limiting.

In the present disclosure, the distal end of a component or of a device means the end furthest away from the hand of the user and the proximal end means the end closest to the hand of the user, when the component or device is in the use position, i.e., when the user is holding a catheter insertion device in preparation for or during use. Similarly, in this application, the terms “in the distal direction” and “distally” mean in the direction toward the distal tip of the needle or catheter of the system, and the terms “in the proximal direction” and “proximally” mean in the direction opposite the direction of the distal tip of the needle or catheter.

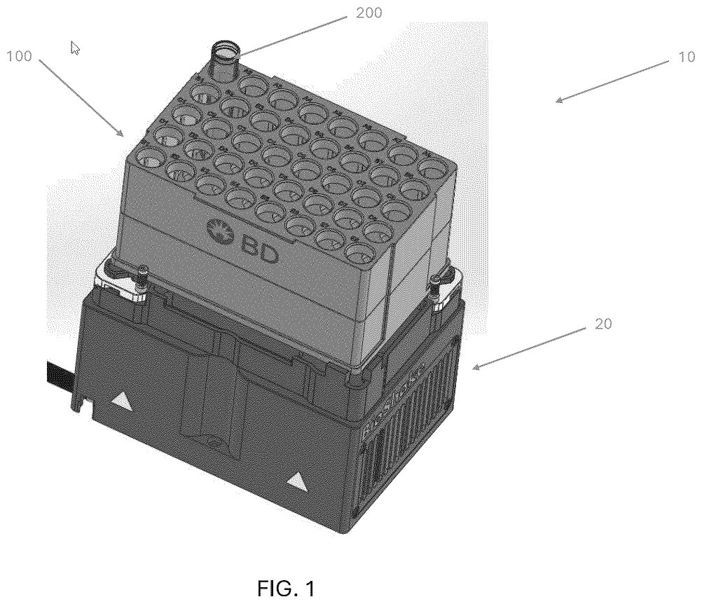

Referring to FIG. 1, a system 10 for sample agitation and heating-cooling is shown, according to one aspect or embodiment of the disclosure. The system 10 generally includes a thermally controllable agitation (or shaking) device 20 and a tube holder 100, with the tube holder 100 useable with the device 20 for preparation of a sample for testing. In some embodiments, the tube holder 100 is suitable for retaining an array of Falcon® 5 mL round bottom polystyrene test tubes therein, e.g., forty (40) Falcon tubes, but it is recognized that the tube holder 100 may otherwise be configured to hold multiple different types and/or numbers of tubes therein, according to additional aspects of the disclosure.

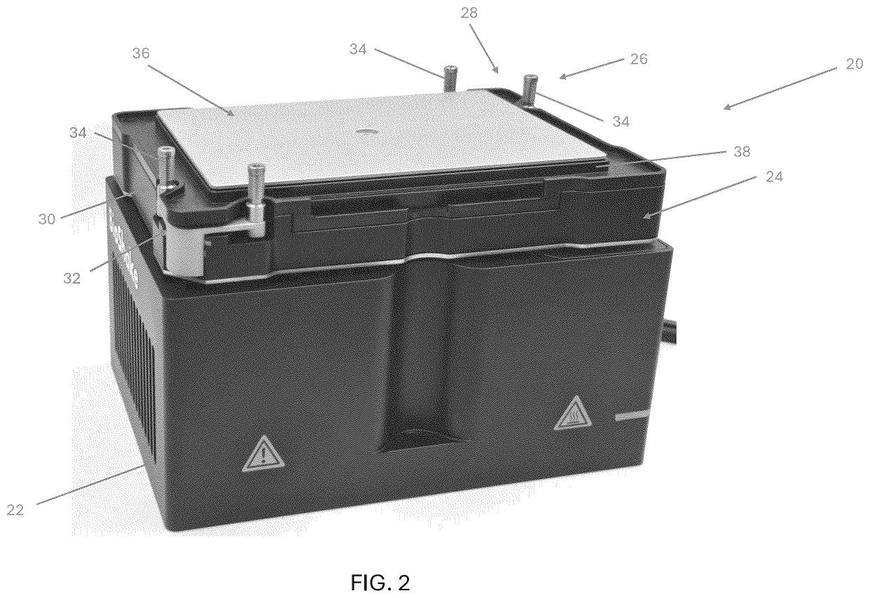

As shown in FIG. 1 and FIG. 2, the thermally controllable agitation device 20 serves for the releasable attachment of a specimen holder (such as tube holder 100) to its upper side. The device 20 shown has a stationary support body 22 as a lower part and a main component 24 movably mounted thereon as an upper part, wherein the latter functions for the releasable receipt of the specimen holder.

A first positioning fixture 26 for fastening to a first edge region of a specimen holder and which can be moved linearly outwards or inwards is provided on an upper side of the main component 24. The first positioning fixture 26 is disposed at a first corner 28 of the main component 24. Furthermore, a further positioning fixture 30 for application to a second edge region of the specimen holder and which can be moved linearly outwards or inwards is provided on the upper side of the main component 24. The second positioning fixture 30 is disposed at a second corner 32 of the main component 24. As an alternative, the second positioning fixture 30 can also be rigidly attached to the main component 24. Both the first positioning fixture 26 and the second positioning fixture 30 each have two positioning pins 34, between which a respective corner region of a rectangular specimen holder can be engaged in order to securely clamp the specimen holder between the positioning fixtures 28, 30. The first positioning fixture 26 and the second positioning fixture 30 (i.e., pins 34 thereof) may be moved inwardly and outwardly by means of an actuating device (not shown), so that the) the specimen holder can be transposed between an engaging or secure configuration and a released configuration for placing or removing the specimen holder.

Device 20 also includes an arrangement of a thermal coupling plate and a flat top adapter (collectively indicated at 36) on an exposed upper side or mounting surface of the main component 24. The arrangement 36 includes a thermal coupling plate that may be fabricated from a highly thermally conductive material (for example from a metal) in order to control the temperature of the specimen holder and the liquid medium contained in it, in particular to heat it or cool it. The thermal coupling plate forms a part of a loading surface of the specimen holder and may be surrounded by a thermally insulating frame 38 (for example produced from plastic). The flat top adapter of arrangement 36 present a flat planar surface to which a flat-bottomed specimen holder (e.g., tube holder 100) may be attached. The flat top adapter lies directly and substantially over the entire surface of the thermal coupling plate and is inserted into the thermally insulating frame 38 in an interlocking manner.

While not shown in FIGS. 1 and 2, it is recognized that device 20 may include control electronics that function to set a temperature of the arrangement 36 of the thermal coupling plate and the flat top adapter, to therefore also set the temperature of the specimen contained with the specimen holder attached thereto. The control electronics may include a microprocessor that can be integrated into the device 20 for this purpose, with feedback control being used to maintain the arrangement 36 at a defined temperature that may be above or below the ambient temperature (e.g., from 20° C. to 120° C.). Furthermore, device 20 can be configured for communication with an external, higher-level system via one or more suitable communication interfaces, such as CAN, Bluetooth, WLAN and USB, as non-limiting examples.

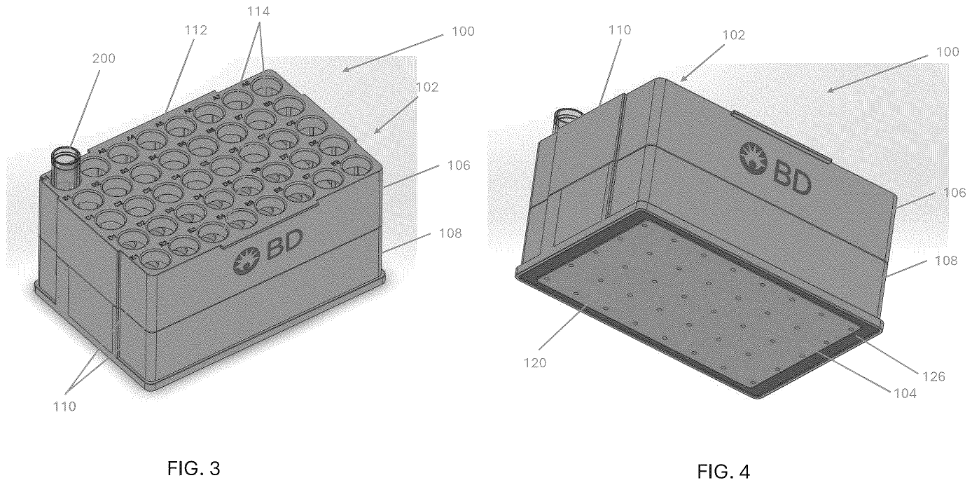

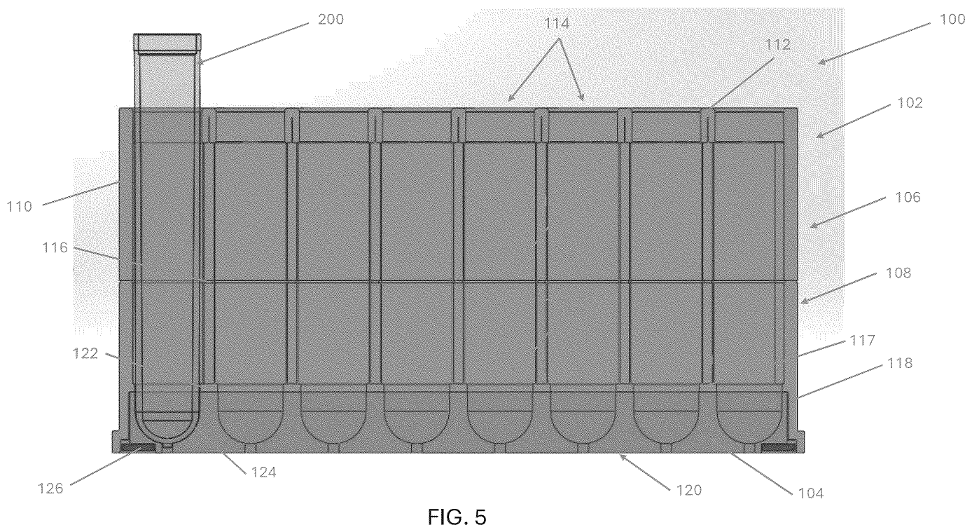

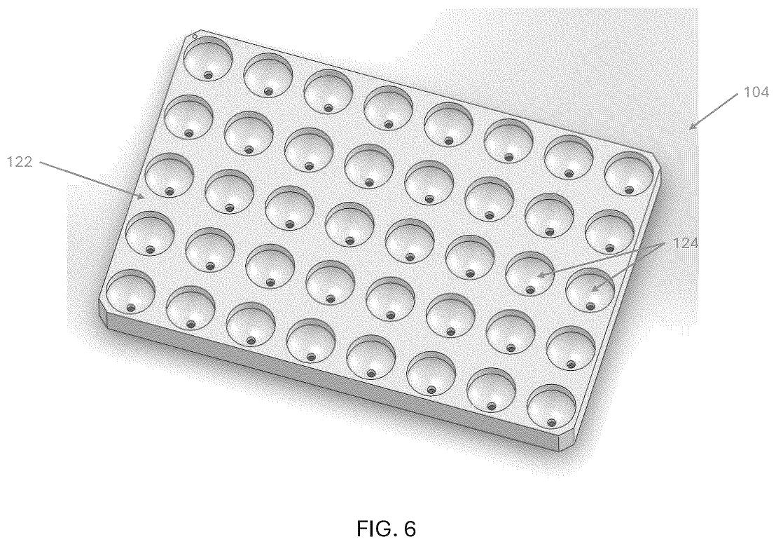

Referring now to FIGS. 3-6, detailed views of the tube rack 100 are shown in accordance with an aspect of the disclosure. The tube rack 100 has a hybrid construction, with portions thereof formed of a thermally insulating material such as plastic and portions thereof formed of a thermally conducting material such as aluminum or another thermally conducting metal. In particular, tube rack 100 includes a frame 102 formed of a thermally insulating material (e.g., plastic) and an insert 104 formed of a thermally conducting material (e.g., aluminum or another thermally conductive metal).

Frame 102 of tube rack 100 includes a top frame portion 106 and a bottom frame portion 108 that may have a generally box-shaped or rectangular profile of similar/identical size. The top frame portion 106 and bottom frame portion 108 are stacked in a vertical arrangement and may be integrally formed or may be otherwise secured/connected with each other. Each of the top and bottom frame portions 106, 108 includes an arrangement of four (4) sidewalls 110 that generally define an inner volume of the tube rack 100, with the sidewalls 110 provided a generally enclosed frame 102 within which specimen tubes 200 are retained. The top frame portion 106 of frame 102 also includes an upper member 112 having a plurality of openings 114 formed therein. The openings 114 are sized to accommodate positioning of tubes 200 therein in a secure manner, and the number of openings 114 may vary depending on design considerations-with forty (40) openings 114 being shown in FIG. 3 according to one embodiment. Similar to top frame portion 106, bottom frame portion 108 of frame 102 may also include an upper member 116 having a plurality of openings 114 formed therein-with the number and locations of the openings 114 being identical to those in the upper member 112 of top frame portion 106. Bottom frame portion 108 of frame 102 may also include a lower member 117 having a plurality of openings 114 formed therein-with the number and locations of the openings 114 being identical to those in the upper members 112, 116. With the openings 114 in upper members 112, 116 and lower member 117 arranged as such, tubes 200 retained by tube rack 100 may be supported at multiple locations along a length thereof.

In some embodiments, the upper member 112 of top frame portion 106 may be marked with well location identifiers, as is customary with multi-specimen trays and plates.

As shown best in FIG. 4, the bottom frame portion 108 includes a receptacle 118 at a lower end thereof. The receptacle 118 is defined by the sidewalls 110 and is configured to receive and retain the conductive insert 104 of tube rack 100 therein. In some embodiments, the sidewalls 110 may include retaining features thereon, such as clips or a lip extending inwardly therefrom, that function to secure the conductive insert 104 within the receptacle 118. The bottom frame portion 108, including sidewalls 110 thereof, includes outer geometry features that mimic standard specimen plates, so that it can be installed and secured on the device 20 using the first positioning fixture 26 and the second positioning fixture 30 thereof.

As shown in FIGS. 4-6, the conductive insert 104 includes a flat bottom surface 120 that is configured to sit directly on the arrangement 36 of the thermal coupling plate and the flat top adapter of device 20, so as to provide direct thermal contact between the arrangement 36 and the insert 104. A top surface 122 of the conductive insert 104 has wells 124 formed therein equal in number and arrangement to the openings 114 formed in upper members 112, 116 of the frame 102. Each well 124 has a semi-spherical configuration configured to receive and cup a spherical bottom end of a respective tube 200. With the wells 124 configured as such, an area of surface contact between the conductive insert 104 and the tubes 200 is maximized, so as to provide an efficient transfer of thermal energy from the conductive insert 104 to the tubes 200, in order to heat or cool the tubes 200 as desired. The conductive insert 104 is designed with minimized mass, to prevent degradation of agitation performance by the device 20, so as to provide for proper preparation of the specimen contained in tubes 200 as desired.

In some embodiments, a rectangular insulator piece 126 may be applied to the flat bottom surface 120 of the conductive insert 104, around a perimeter thereof, so as to cover the outer edges on the bottom surface 120 of the conductive insert 104. The insulator piece 126 may be formed of plastic or another suitable thermally insulating material, with the insulator piece 126 functioning to prevent condensation buildup on what would otherwise be exposed metal surfaces of the conductive insert 104 that extend beyond the dimensions of the arrangement 36 of the thermal coupling plate and flat top adapter of the device 20.

With the tube rack 100 constructed as described above, temperature regulation of the specimen within tubes 200 is optimized. The positioning and configuration of the conductive insert 104—with the flat bottom surface 120 and wells 124 that cup the spherical bottom end of the tubes 200—provides for direct conduction/transfer of thermal energy from the device 20 (i.e., from the arrangement 36 of the thermal coupling plate and flat top adapter) to the conductive insert 104 and to the tubes 200 retained by tube rack 100. The construction of the frame 102—with sidewalls 110 of top and bottom frame portions 106, 108 that surround an interior volume of the tube rack 100 and provide a receptacle 118 for the conductive insert 104—provide insulation for the tubes 200 from the ambient room temperature, thereby allowing for more uniform temperature control of all tube locations and the specimens therein in the tube rack 100, and provide for more efficiency of the system 10 by enclosing the localized temperature controlled area and covering surfaces of the conductive insert 104.

Following here below are a number of methods for fabricating the tube rack 100 described above.

In one embodiment, the conductive insert 104 is insert molded to the bottom frame portion 108 and to the insulator piece 126, with the top frame portion 106 then being ultrasonically welded to the lower insert molded sub-assembly.

In another embodiment, the conductive insert 104 is glued to the bottom frame portion 108 and to the insulator piece 126, with the top frame portion 106 then being glued to the lower glued sub-assembly.

In another embodiment, the conductive insert 104 is glued to the bottom frame portion 108 and to the insulator piece 126, with the top frame portion 106 then being ultrasonically welded to the lower glued sub-assembly.

In another embodiment, the conductive insert 104 is ultrasonically or thermally welded to the bottom frame portion 108 and to the insulator piece 126, with the top frame portion 106 then being ultrasonically welded to the lower welded sub-assembly.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment may be combined with one or more features of any other embodiment.

The invention claimed is:

1. A tube rack for use with a thermally controllable agitation device, the tube rack comprising:
a frame including a top frame portion and a bottom frame portion in a stacked arrangement, each of the top frame portion and the bottom frame portion including a plurality of sidewalls defining an inner volume, and each of the top frame portion and the bottom frame portion including one or more members having an array of openings formed therein, the array of opening configured to receive and retain specimen tubes therein; and
an insert retained within the frame at a bottom end thereof, the insert comprising a flat bottom surface and a top surface that includes a plurality of wells formed therein configured to receive a rounded bottom end of the specimen tubes;
wherein the frame is formed of a thermally insulating material and the insert is formed of a thermally conducting material.

2. The tube rack of claim 1, wherein the bottom frame portion comprises a receptacle formed therein, at a bottom end thereof, the receptacle defined by the plurality of sidewalls and configured to retain the insert therein.

3. The tube rack of claim 2, wherein the one or more members of the bottom frame portion comprises:
another upper member positioned at a top edge of the plurality of sidewalls; and
a bottom member, with the bottom member defining a back surface of the receptacle.

4. The tube rack of claim 1, wherein the one or more members of the top frame portion comprises an upper member positioned at a top edge of the plurality of sidewalls.

5. The tube rack of claim 1, further comprising an insulator piece applied to the flat bottom surface of the insert, around a perimeter thereof, so as to cover the outer edges on the flat bottom surface, the insulator piece formed of a thermally insulating material.

6. The tube rack of claim 5, wherein the conductive insert is insert molded, glued, or ultrasonically or thermally welded to the bottom frame portion and to the insulator piece.

7. The tube rack of claim 1, wherein the top frame portion and the bottom frame portion are joined via ultrasonic welding or gluing.

8. The tube rack of claim 1, wherein each of the plurality of wells comprises a semi-spherical well.

9. The tube rack of claim 1, wherein the thermally insulating material comprises plastic.

10. The tube rack of claim 1, wherein the thermally conducting material comprises aluminum.

11. The tube rack of claim 1, wherein with the tube rack affixed to the thermally controllable agitation device, the flat bottom surface of the insert is in direct contact with a thermal coupling plate or a flat top adapter of the thermally controllable agitation device.

12. The tube rack of claim 1, wherein the specimen tubes are arranged within the inner volume of the frame, with the plurality of sidewalls thermally insulating the specimen tubes from the ambient environment.
